(19) United States
(12) Patent Application Publication
(10) Pub. No.: US 2008/0309770 A1
(43) Pub. Date: Dec. 18, 2008

(54) METHOD AND APPARATUS FOR SIMULATING A CAMERA PANNING EFFECT

(75) Inventors: Laura Florea, Bucuresti (RO); Peter Corcoran, Claregalway (IE); Adrian Zamfir, Bucuresti (RO)

Correspondence Address: FotoNation;Patent Legal Dept., 3099 Orchard Drive, San Jose, CA, 95134, US

(73) Assignee: FOTONATION VISION LIMITED, Galway City (IE)

(21) Appl. No.: 11/764,578

(22) Filed: Jun. 18, 2007

(51) Int. Cl. G06K 9/20

(52) U.S. Cl. 348/208.4

(57) ABSTRACT

A digital image acquisition system determines a motion function of a subject/object in an acquired image scene based on a comparison of a reference image of nominally the same scene taken outside the exposure period of the acquired image and at least one other image. The acquired image is segmented into a foreground portion and a background portion and a background portion of the acquired image is convolved according to the motion function. The foreground portion and the convolved background portion are composited to produce a final image in which panning of a camera during image acquisition is simulated.

### BACKGROUND

The present invention relates to a method and apparatus for simulating a camera panning effect.

It is often desirable, particularly in the field of sports photography, to capture an image depicting a sense of motion of a subject/object.

In digital cameras, when an image comprising a subject/object in motion is captured using a relatively short exposure time and a small aperture, the subject/object and background will appear motionless. On the other hand, when an image comprising a subject/object in motion is captured using a relatively long exposure time, the subject/object and background can appear blurred.

Thus, in order to capture an image depicting a sense of motion, a technique known as camera panning is employed.

Manual camera panning involves a user opening a camera shutter and tracking a moving subject/object during acquisition before closing the shutter, to thereby acquire an image comprising a blurred background and a relatively sharp subject/object, as is disclosed at http://www.ephotozine.com/article/Camera-panning.

However, the camera panning technique is dependent on a number of factors, for example, speed of the subject/object, distance to the subject/object and focal length used. The ability of the photographer to pan the camera in order to (blindly) track a subject/object is also key to acquiring an image of the subject/object in motion. Poor technique can result in blurring of both the subject/object and the background due to hand motion. Thus, it can be quite difficult to acquire an image depicting a sense of motion of the subject/object by manual camera panning.

http://www.photos-of-the-year.com/panning/ discloses a method of enhancing an acquired digital image to depict a sense of motion of an object using MS Photoshop. The technique involves manually extracting a foreground layer comprising the object from the image, and applying an Unsharp Mask filter to the object to sharpen it. Visibility of the foreground layer of the image comprising the object is temporarily switched off and the background layer is manually blurred using a synthetic blur tool. The visibility of the foreground layer is then switched on again to produce a digitally panned image. It will be seen however, that this involves a significant degree of user intervention and is a technique which would prove extremely difficult to implement or use in a portable image capture device such as a camera.

It is desired to have an improved method of acquiring an image depicting a sense of motion of the subject/object.

### SUMMARY OF THE INVENTION

A method operable in a digital image acquisition system having no photographic film is provided. The method includes acquiring a digital image of a scene; determining a motion function of a subject/object in said scene based on a comparison of a reference image of nominally the same scene taken outside the exposure period of said acquired image and at least one other image; segmenting said acquired image into a foreground portion and a background portion; convolving said background portion of said acquired image according to said motion function; and compositing said foreground portion and said convolved background portion to produce a final image.

A digital image acquisition system is also provided including an apparatus for capturing digital images; a digital processing component for determining a motion function of a subject/object in said scene based on a comparison of a reference image of nominally the same scene taken outside the exposure period of said acquired image and at least one other image; a segmentation tool for segmenting said acquired image into a foreground portion and a background portion; a convolver for convolving said background portion of said acquired image according to said motion function; and a compositor for compositing said foreground portion and said convolved background portion to produce a final image.

### BRIEF DESCRIPTION OF DRAWINGS

Embodiments of the invention will now be described, by way of example, with reference to the accompanying drawings, in which:

FIG. 1 is a block diagram of a digital image acquisition apparatus operating in accordance with certain embodiments; and

FIG. 2 is a workflow illustrating certain embodiments.

### DESCRIPTION OF PREFERRED EMBODIMENTS

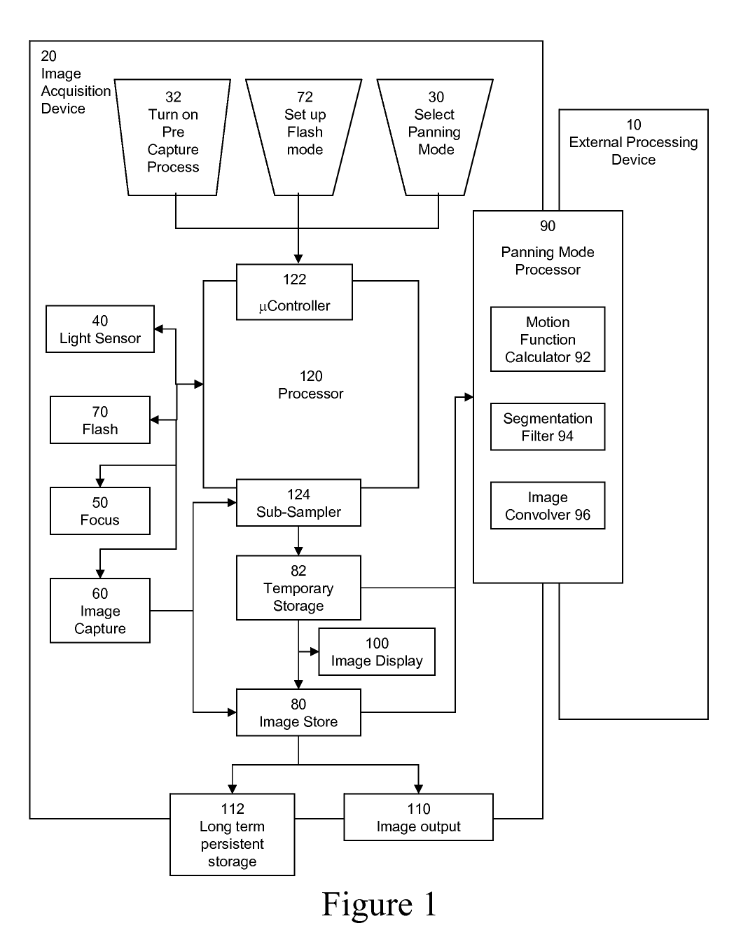

FIG. 1 shows a block diagram of an image acquisition device 20 operating in accordance with embodiments. The digital acquisition device 20, which in the present embodiment is a portable digital camera, includes a processor 120. It can be appreciated that many of the processes implemented in the digital camera may be implemented in or controlled by software operating in a microprocessor, central processing unit, controller, digital signal processor and/or an application specific integrated circuit, collectively depicted as block 120 labeled “processor”. Generically, all user interface and control of peripheral components such as buttons and display is controlled by a microcontroller 122. The processor 120, in response to a user input at 122, such as half pressing a shutter button (pre-capture mode 32), initiates and controls the digital photographic process. Ambient light exposure is monitored using light sensor 40 in order to automatically determine if a flash is to be used. A distance to the subject is determined using a focus component 50, which also focuses the image on image capture component 60. If a flash is to be used, processor 120 causes the flash 70 to generate a photographic flash in substantial coincidence with the recording of the image by image capture component 60 upon full depression of the shutter button. The image capture component 60 digitally records the image in color. The image capture component preferably includes a CCD (charge coupled device) or CMOS to facilitate digital recording. The flash may be selectively generated either in response to the light sensor 40 or a manual input 72 from the user of the camera. The high resolution image recorded by image capture component 60 is stored in an image store 80 which may comprise computer memory such a dynamic random access memory or a non-volatile memory. The camera is equipped with a display 100, such as an LCD, for preview and post-view of images.

In the case of preview images, the display 100 can assist the user in composing the image, as well as being used to determine focusing and exposure. These preview images may be generated automatically or only in the pre-capture mode 32 in response to half-pressing shutter button. In any case, the camera automatically captures and stores a sequence of images at close intervals so that the images are nominally of the same scene as the main image.

Temporary storage 82 is used to store one or more of the preview images and can be part of the image store 80 or a separate component. The preview image is preferably generated by the image capture component 60. For speed and memory efficiency reasons, preview images preferably have a lower pixel resolution than the main image taken when the shutter button is fully depressed, and are generated by sub-sampling a raw captured image using software 124 which can be part of the general processor 120 or dedicated hardware or combination thereof. Depending on the settings of this hardware subsystem, the pre-acquisition image processing may satisfy some predetermined test criteria prior to storing a preview image. Such test criteria may be chronological, such as to constantly replace the previous saved preview image with a new captured preview image every 0.5 seconds during the pre-capture mode 32, until the final high resolution image is captured by full depression of the shutter button. More sophisticated criteria may involve analysis of the preview image content, for example, testing the image for changes, before deciding whether the new preview image should replace a previously saved image. Other criteria may be based on image analysis such as the sharpness, or metadata analysis such as the exposure condition, whether a flash is going to happen, and/or the distance to the subject.

If test criteria are not met, the camera continues by capturing the next preview image without saving the current one. The process continues until the final high resolution image is acquired and saved by fully depressing the shutter button.

Where multiple preview images can be saved, a new preview image will be placed on a chronological First In First Out (FIFO) stack, until the user takes the final picture. The reason for storing multiple preview images is that the last preview image, or any single preview image, may not be the best reference image for comparison with the final high resolution image in, for example, a red-eye correction process.

The camera is also able to capture and store in the temporary storage 82 one or more low resolution post-view images. Post-view images are preferably the same as preview images, except that they occur after the main high resolution image is captured.

In the present embodiment, the camera 20 preferably has a user-selectable panning mode 30 and a panning mode processor 90. Panning mode may be selected either pre- or post-acquisition of a main image. By selecting panning mode in advance of main image acquisition, the user prompts the processor 90 to store the preview images acquired immediately before main image acquisition. If panning is selected after main image acquisition, it relies on preview images being available either in memory or stored with the image.

The panning mode processor 90 further processes the stored images according to a workflow to be described. The processor 90 can be integral to the camera 20—indeed, it could be the processor 120 with suitable programming—or part of an external processing device 10 such as a desktop computer. In this embodiment the processor 90 receives a main high resolution image from the image store 80 as well as one or more pre- or post-view images from the temporary storage 82.

Where the panning mode processor 90 is integral to the camera 20, the final processed image may be displayed on image display 100, saved on a persistent storage 112 which can be internal or a removable storage such as CF card, SD card or the like, or downloaded to another device, such as a personal computer, server or printer via image output means 110 which can be tethered or wireless. In embodiments where the processor 90 is implemented in an external device 10, such as a desktop computer, the final processed image may be returned to the camera 20 for storage and display as described above, or stored and displayed externally of the camera.

The panning mode processor 90 comprises a motion function calculator 92. Preferably, the motion function is a Point Spread Function, PSF. The PSF represents a path of a subject/object during the exposure integration time. The PSF is a function of a motion path and a motion speed, which determines an integration time, or an accumulated energy for each point of a moving subject/object.

A segmentation filter 94 analyzes the main image for foreground and background characteristics before forwarding the image along with its foreground/background segmentation information for further processing or display. In the preferred embodiment, the processor 90 comprises the filter 94. However, the filter 94 can be integral to the camera 20 or part of an external processing device 10 such as a desktop computer, a hand held device, a cell phone handset or a server. In this embodiment, the segmentation filter 94 receives the captured image from the main image storage 80 as well as one or a plurality of preview images from the temporary storage 82.

The panning mode processor 90 further comprises an image convolver 96, which receives foreground/background segmentation information from the filter 94. The image convolver 96 convolves the background portion of the main image using the calculated motion function from the calculator 92 in order to depict a sense of motion of the subject/object in the final image.

The motion function calculator 92 may be used for qualification only, such as determining if sufficient motion exists, while the segmentation filter 94 and image convolver 96 may be activated only after the motion function calculator has determined if blurring is required. Such a determination may be based on a comparison of the motion function with threshold values and/or user selection.

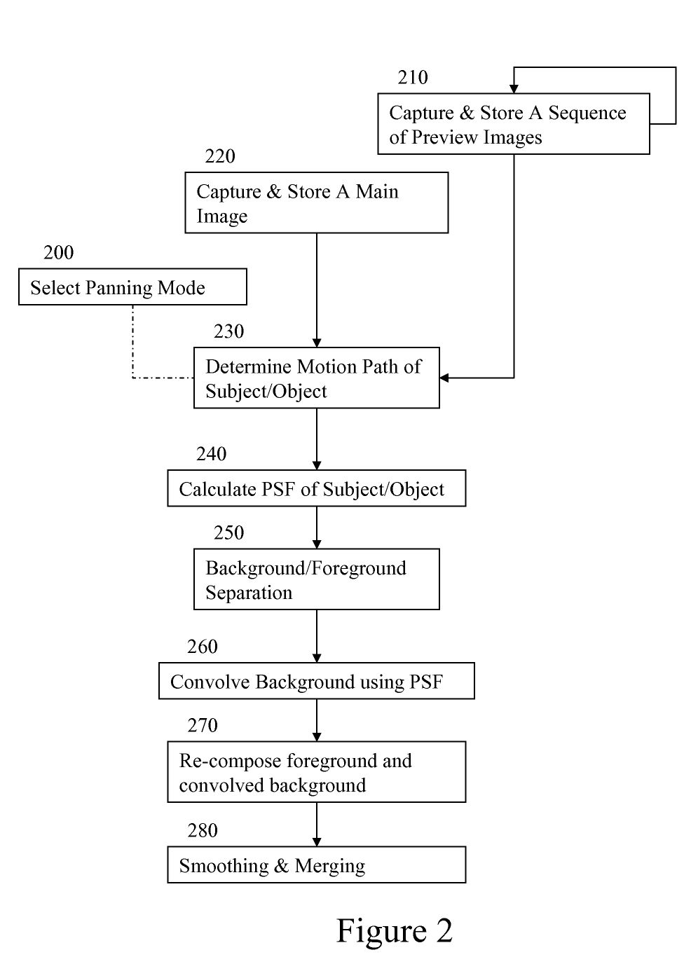

FIG. 2 illustrates the workflow of a preferred embodiment of panning mode processing according to certain embodiments.

First, panning mode 30 is selected, step 200. Now, when the shutter button is fully depressed, the camera automatically captures a main image 220 of a scene comprising a moving subject/object and stores a sequence of preview images 210 acquired immediately prior to or after the acquisition of the main image. Preferably, the main image is a full resolution image.

It will be appreciated that the acquired sequence of pre- or post-view images may comprise only a single preview image.

It will also be appreciated that panning mode may be selected after the capturing of the images. For example, where a main image and a sequence of pre- or post-images depicting the same scene are available, panning mode may be selected to alter the images according to the remainder of the workflow described below in order to produce an image depicting a subject/object in motion.

From the sequence of preview and the main image, a detailed motion path of the subject/object is determined, 230. However, it will be appreciated that in further embodiments, the detailed motion path of the subject/object may be determined from the sequence of preview images only, a sequence of post-view images only, or a sequence of post-view images and the main image.

In the embodiment, this is achieved by selecting one or more distinctive regions of the subject/object in a preview image. In general, such distinctive regions are regions with noticeable difference in contrast or brightness that can be isolated from the background of the image. It will be appreciated that in one embodiment, a region may comprise a single fiduciary point.

Each region is then matched with the corresponding regions in each of the preview image sequence. The coordinates of each region are recorded for the preview images and also for the main image.

Preferably, all images are recorded with an exact time stamp associated with them to ensure correct tracking of the subject/object through the sequence of preview images.

When the main image is acquired, a time interval between the last captured preview image and the main image, as well as the duration of the exposure of the main image is recorded.

In the alternative embodiments, where the detailed motion path is determined from a sequence of post-view images only, or a sequence of post-view images and the main image, the time interval between the captured main image and the first captured post-view image as well as the duration of the exposure of the main image is recorded.

Based on the tracking before the image was captured, and the interval before and duration of the main image, the movement of single points or high contrast image features is extrapolated to determine the detailed motion path of the subject/object.

An extrapolation of the motion path of the subject/object through the preview images enables the motion function of the subject/object in the main image to be calculated, 240.

In the preferred embodiment, the motion function is a PSF, the determination of which is described in more detail in U.S. patent application Ser. No. 10/985,657, filed on Nov. 10, 2004.

Nonetheless, other techniques for defining a motion function for the main image from at least two images can be employed.

Next, the main image undergoes foreground/background separation, 250, in order to extract the subject/object from the sharp main image. A detailed explanation of foreground/background separation methods is described in detail in U.S. patent application Ser. No. 11/217,788 filed on Aug. 30, 2005 and in International Patent Application No. PCT/EP2006/008229 filed on Aug. 21, 2006. As disclosed in these applications, foreground/background separation may be carried out based on an analysis of a flash and non-flash version of an image, or alternatively, based solely on an analysis of non-flash versions of an image.

In any case, it will be seen that the reference image used to enable foreground background separation of the main image can be one of the reference images used in calculating the motion function for simulating panning of the main image, and so use of such reference images enables the ready implementation and use of portable image acquisition devices as well as in general purpose computers with features described herein.

In any case, the background portion of the main image is then convolved, 260, using the calculated motion function, to produce a blurred background, as is well known in the art.

The foreground comprising the sharp subject/object and the blurred background are then composited 270 to produce a final image wherein the subject/object is depicted as having a sense of motion.

In the preferred embodiment, the final image is subjected to smoothing and merging operations 280 across boundary portions between the foreground subject/object and the artificially blurred background.

In a further embodiment, the user selectable panning mode 30 further comprises a blur adjustment module. The blur adjustment module comprises a motion function scaling parameter that can be altered, either manually or automatically, to allow a user to define the degree of motion blur which is to be applied to the background portion of the main image, and thereby the degree of motion of the subject/object depicted in said main image.

In the case where the motion function scaling parameter is manually altered, the blur adjustment module is preferably implemented as a user interface slider widget to allow the user to easily select the degree of scaling to be applied to the motion function, before the motion function is applied or re-applied to the background of the composite image.

However, it will be appreciated that the blur adjustment module may be implemented as a button or plurality of buttons. Thus, for example, where the subject is a moving person, button or slider options such as “walking motion”, “jogging motion”, “sports action”, and “extreme motion” may be available to the user to more aptly capture the movement of the subject in the image.

The present invention is not limited to the embodiments described above herein, which may be amended or modified without departing from the scope of the present invention as set forth in the appended claims, and structural and functional equivalents thereof.

In methods that may be performed according to preferred embodiments herein and that may have been described above and/or claimed below, the operations have been described in selected typographical sequences. However, the sequences have been selected and so ordered for typographical convenience and are not intended to imply any particular order for performing the operations.

In addition, all references cited above herein, in addition to the background and summary of the invention sections, and U.S. Ser. Nos. 11/673,560, 11/566,180 and 11/753,098 which are assigned to the same assignee as the present application, are hereby incorporated by reference into the detailed description of the preferred embodiments as disclosing alternative embodiments and components.

What is claimed is:

1. A method operable in a digital image acquisition system having no photographic film, said method comprising:
acquiring a digital image of a scene;
determining a motion function of a subject/object in said scene based on a comparison of a sequence of reference images of nominally the same scene taken outside the exposure period of said acquired image and at least one other image;
segmenting said acquired image into a foreground portion and a background portion;
convolving said background portion of said acquired image according to said motion function; and
compositing said foreground portion and said convolved background portion to produce a final image.

2. The method according to claim 1 further comprising:
merging and smoothing said foreground portion and said convolved background portion in said final image.

3. The method according to any preceding claim wherein said motion function is a Point Spread Function, PSF.

4. The method according to any preceding claim wherein said sequence of reference images comprises a single image.

5. The method according to claim 1 wherein said segmenting of said acquired image comprises analyzing said acquired image and one of said sequence of reference images.

6. A digital image acquisition system comprising:
an apparatus for capturing digital images;
a digital processing component for determining a motion function of a subject/object in said scene based on a comparison of a reference image of nominally the same scene taken outside the exposure period of said acquired image and at least one other image;
a segmentation tool for segmenting said acquired image into a foreground portion and a background portion;
a convolver for convolving said background portion of said acquired image according to said motion function; and
a compositor for compositing said foreground portion and said convolved background portion to produce a final image.

7. The digital image acquisition system according to claim 6 further comprising:
a blur adjustment module for selectively altering a motion function scaling parameter to alter the degree to which the background portion is to be blurred.

8. The digital image acquisition system according to claim 7, wherein said blur adjustment module is implemented as a user adjustable slider.

9. The digital image acquisition system according to claim 7, wherein said blur adjustment module is implemented as at least one user adjustable button.

10. The digital image acquisition system according to claim 7 comprising one of a digital stills camera, a digital video camera, or a camera phone.
